(19) United States
(12) Patent Application Publication
(10) Pub. No.: US 2003/0185120 A1
(43) Pub. Date: Oct. 2, 2003

(54) Optical disk player and method of optimum power control test

(76) Inventors: Mikio Morozumi, Nagano (JP); Yoshinori Masuzawa, Nagano (JP)

Correspondence Address: BIRCH STEWART KOLASCH & BIRCH, PO BOX 747, FALLS CHURCH, VA, 22040-0747, US

(21) Appl. No.: 10/186,674

(22) Filed: Jul. 2, 2002

(30) Foreign Application Priority Data
Jan. 7, 2002 (JP) 2002-741

(51) Int. Cl. G11B 7/125

(52) U.S. Cl. 369/47.52; 369/47.53; 369/53.31

(57) ABSTRACT

The optical disk player is capable of selectively executing the optimum power control test in power calibration areas and shortening the time for writing data if required. The optical disk player of the present invention writes data on an optical disk having a first power calibration area located on an inner side of a read-in area and a second power calibration area located on an outer side of a read-out area. A type of optimum power control test executed in one of the power calibration areas or in the both of the power calibration areas is selected. The optimum power control test is executed in one of the power calibration areas or in the both of the power calibration areas on the basis of the type of optimum power control test selected.

### BACKGROUND OF THE INVENTION

The present invention relates to an optical disk player, which is capable of writing data on an optical disk, e.g., a CD-R, a CD-RW, and a method of optimum power control (OPC) test of the optical disk.

CD-R players and CD-RW players are used for writing data on optical disks as optical disk players.

In the conventional optical disk players, rotational speed of an optical disk is controlled by a CLV (Constant Liner Velocity) manner, in which liner velocity of writing data is fixed to maintain pit density. In the CLV manner, to maintain the liner velocity, the rotational speed of the optical disk should be faster when data are written in an inner part of the optical disk; the rotational speed of the optical disk should be slower when data are written in an outer part of the optical disk.

These days, acceleration of the speed of writing data on the optical disk has been required. But, in the case of the optical disk player employing the CLV manner, if the rotational speed of the optical disk is merely accelerated, the rotational speed of the inner part is too fast to correctly write data therein.

To correctly writing data in a short time with proper rotational speed, a zone CLV manner was proposed.

The zone CLV manner will be explained with reference to FIG. 8.

In an optical disk 10, user data are written in a writing area 6, which includes an inner zone 6a, an intermediate zone 6b and an outer zone 6c. Date are written from the inner zone 6a to the outer zone 6c with changing the liner velocity. For example, data are written at 16× speed in the inner zone 6a; data are written at 20× speed in the intermediate zone 6b; and data are written at 24× speed in the outer zone 6c. Namely, the liner velocity and the rotational speed of the optical disk 10 are accelerated, in stages, with changing the writing zone from the inner zone 6a to the outer zone 6c. With this manner, total time for writing data on the optical disk 10 can be shorter.

By the zone CLV manner, the data are written in the inner zone 6a of the optical disk 10 with the conventional rotational speed, so that the data can be written without errors. Therefore, data can be securely written without errors in a short time.

In the conventional optical disk player, test data are written as optimum power control (OPC) test in a power calibration area (PCA) 2 so as to properly adjust power of laser beams for writing data.

The OPC test will be explained.

Firstly, data recorded in an absolute time pregroove (ATIP) are read. The data recorded in the ATIP indicate a manufacturer and identification of the optical disk 10, etc.

Note that, recommended laser power for writing data on an optical disk of each disk manufacturer is stored in a memory of the optical disk player.

The optical disk player reads the data of the optical disk from the ATIP, then reads the recommended laser power from the memory on the basis of the disk data. The disk player changes the laser power from the recommended power read and writes test data in the PCA. The disk player reads the written test data so as to check symmetry of wave forms of light intensity of the test data. When good symmetry wave forms are observed, the disk player defines that the present laser power is proper laser power for writing data on the optical disk.

However, in the optical disk player employing the zone CLV manner, the initially defined proper laser power on the basis of the test data written in the PCA is not proper for writing data in the outer zone because the rotational speed of the optical disk is increased when data are written in the outer zone.

Namely, in the optical disk shown in FIG. 8, the proper laser power of the optimum power control test is defined for the 16× speed. But, the liner velocity in the immediate zone 6b and the outer zone 6c are the 20× and 24× speed, so the laser power for the 16× speed is not proper in the immediate zone 6b and the outer zone 6c. Date cannot be correctly written in the zones 6b and 6c with the 16× speed. Generally, the laser power for writing data should be made greater with increasing the liner velocity of the optical disk.

To properly define the laser power, another PCA (a second PCA) 9 is formed on the outer side of the read-out area 8, and another optimum control test is executed in the outer PCA 9.

In the zone CLV manner for the optical disk having the outer PCA 9, the laser power for writing data in the inner part of the disk 10 is defined in the inner PCA 2 (a first PCA); the laser power for writing data in the outer part thereof is defined in the outer PCA 9. Namely, when the liner velocity of writing data is increased, the optimum control test is executed again in the outer PCA 9, so that quality of writing data can be high.

The conventional optical disk player checks if the optical disk has two PCAs or not on the basis of the disk data read from the ATIP. In the case of the optical disk having the two PCAs, the optical disk player automatically executes the optimum power control test in the two PCAs.

However, if the optical disk has the two PCAs, the optical disk player automatically executes the optimum power control test twice, so the time for executing the optimum control test must be longer.

In some cases, the time for executing the optimum control test should be short even if the quality of writing data is low. However, if the optical disk player automatically executes the optimum power control test in the two PCAs, the required time must be longer. Namely, the optimum power control test cannot be selectively executed in one of the PCAs.

Further, in other some cases, data are written in the read-out area 8 and the outer PCA 9. In this case, data will be written in the outer PCA 9, in which the test data has been written. Namely, the data will be written over the test data. However, in the case of writing on a CD-R, the data cannot be written in the outer PCA 9, so the data will be partially lost. While, in the case of writing on a CD-RW, the data can be written over the test data, so quality of writing the overwritten data must be low.

### SUMMARY OF THE INVENTION

The present invention was invented to solve the above described disadvantages of the conventional optical disk player.

An object of the present invention is to provide an optical disk player and a method of the optimum power control test capable of selectively executing the optimum power control test in PCAs and shortening the time for writing data if required.

Another object of the present invention is to provide an optical disk player and a method of the optimum power control test capable of writing data in an outer PCA without making the writing quality lower.

To achieve the objects, the present invention has following structures. Namely, an optical disk player of the present invention, which writes data on an optical disk having a first power calibration area located on an inner side of a read-in area and a second power calibration area located on an outer side of a read-out area,

comprises:

means for selecting a type of optimum power control test executed in one of the power calibration areas or in the both of the power calibration areas; and

control means for executing the optimum power control test in one of the power calibration areas or in the both of the power calibration areas on the basis of the selecting means.

With this structure, the optimum power control test can be executed in the both PCAs so as to make the writing quality high, and the optimum power control test can be selectively executed in one of the both PCAs so as to shorten the time for writing data. Namely, the type of optimum power control test can be optionally selected. Another optical disk player, which writes data on an optical disk having a first power calibration area located on an inner side of a read-in area and a second power calibration area located on an outer side of a read-out area,

comprises:

means for detecting a type of writing data; and

control means for executing optimum power control test in the first power calibration area only if the type of writing data detected by the detecting means indicates that data can be written in the both power calibration areas.

With this structure, test data are written in the first PCA only even if data can be written in the second PCA. Therefore, no data are written in the second PCA. In the case of a CD-R, the data can be written in the second PCA. While, in the case of a CD-RW, data can be written in the second PCA in which no data have been written, so quality of writing the data can be high.

In the optical disk player, the control mans may execute the optimum power control test in the first power calibration area only if the type of writing data detected by the detecting means is a session-at-once type or a disk-at-once type.

And, the optical disk player may further comprise means for selecting a type of optimum power control test executed in one of the power calibration areas or in the both of the power calibration areas if the type of writing data detected by the detecting means indicates that data can be written in the second power calibration area,

wherein the control means executes the optimum power control test in one of the power calibration areas or in the both of the power calibration areas on the basis of the selecting means.

With this structure, time for writing data can be shortened by executing the optimum power control test in one of the PCAs. On the other hand, the quality of writing data can be increased by executing the optimum power control test in the both PCAs. A user can select the type of the optimum power control test optionally.

A method of optimum power control test of an optical disk having a first power calibration area located on an inner side of a read-in area and a second power calibration area located on an outer side of a read-out area,

comprises the steps of:

selecting a type of the optimum power control test executed in one of the power calibration areas or in the both of the power calibration areas; and

executing the optimum power control test in one of the power calibration areas or in the both of the power calibration areas on the basis of the result of the selecting step.

With this method, the optimum power control test can be executed in the both PCAs so as to make the writing quality high, and the optimum power control test can be selectively executed in one of the both PCAs so as to shorten the time for writing data. Namely, the type of optimum power control test can be optionally selected.

Another method of optimum power control test of an optical disk having a first power calibration area located on an inner side of a read-in area and a second power calibration area located on an outer side of a read-out area,

comprises the steps of:

detecting a type of writing data on the optical disk; and

executing the optimum power control test in the first power calibration area only if the type of writing data detected in the detecting step indicates that data can be written in the both power calibration areas.

With this method, test data are written in the first PCA only even if data can be written in the second PCA. Therefore, no data are written in the second PCA. In the case of a CD-R, the data can be written in the second PCA. While, in the case of a CD-RW, data can be written in the second PCA in which no data have been written, so quality of writing the data can be high.

Further, a method of optimum power control test of an optical disk having a first power calibration area located on an inner side of a read-in area and a second power calibration area located on an outer side of a read-out area,

comprises the steps of: detecting a type of writing data on the optical disk; and

executing the optimum power control test, wherein the optimum power control test is executed in the first power calibration area only if the type of writing data detected in the detecting step indicates that data can be written in the second power calibration area, or a type of the optimum power control test executed in one of the power calibration areas or in the both of the power calibration areas is selected if the type of writing data detected in the detecting step indicates that data cannot be written in the second power calibration area, and the optimum power control test is executed in one of the power calibration areas or in the both of the power calibration areas.

With this method, no data are written in the second PCA. In the case of a CD-R, the data can be written in the second PCA. While, in the case of a CD-RW, data can be written in the second PCA in which no data have been written, so quality of writing the data can be high.

### BRIEF DESCRIPTION OF THE DRAWINGS

Embodiments of the present invention will now be described by way of examples and with reference to the accompanying drawings, in which:

FIG. 1 is a block diagram of an optical disk player, in which the method of optimum power control test of first to third embodiments are executed;

FIG. 2 is a flow chart of the method of the first embodiment;

FIG. 3 is a part of a flow chart of the method of the second embodiment;

FIG. 4 is a continuation part of the flow chart shown in FIG. 3;

FIG. 5 is a part of a flow chart of the method of the third embodiment;

FIG. 6 is a continuation part of the flow chart shown in FIG. 5;

FIG. 7 is another continuation part of the flow chart shown in FIG. 5; and

FIG. 8 is an explanation view of an optical disk.

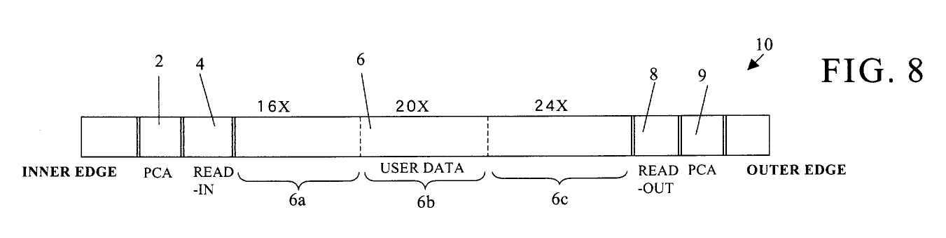

### DETAILED DESCRIPTION OF THE PREFERRED EMBODIMENTS

Preferred embodiments of the present invention will now be described in detail with reference to the accompanying drawings.

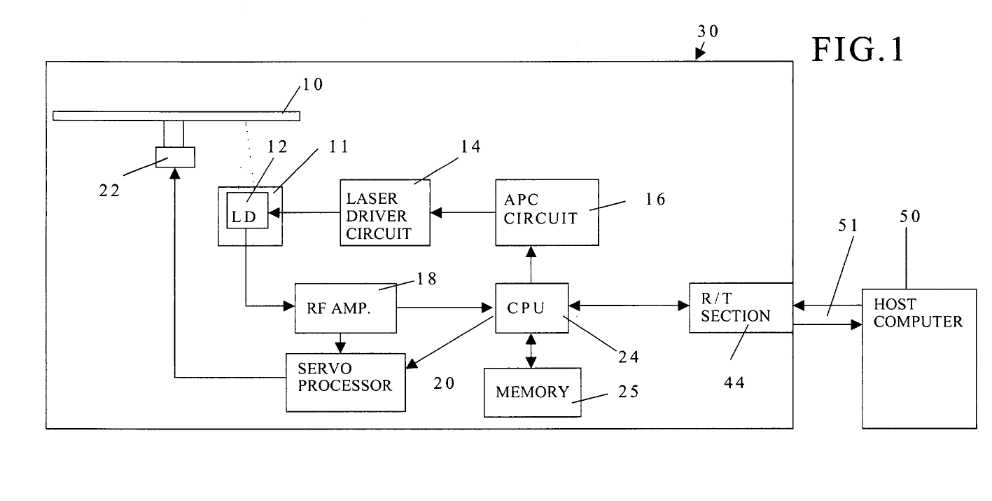

FIG. 1 is a block diagram of an optical disk player 30. Firstly, the structure of the optical disk player 30 will be explained.

The optical disk player 30 writes data on an optical disk 10, e.g., a CD-R, a CD-RW.

The optical disk player 30 is directly connected to a host computer 50 or connected thereto via communication lines. In the present example, the optical disk player 30 is connected to the host computer 50 via communication lines 51. A user inputs data to the host computer 51, which stores application programs for writing data, so as to write the data on the optical disk 10.

The optical disk player 30 includes: a laser diode (LD) 12 for irradiating a laser beam to the optical disk 10; a laser driver circuit 14 for supplying electric current to the LD 12; and an automatic power control (APC) circuit 16 for controlling electric voltage applied to the laser driver circuit 14.

The LD 12 is assembled in an optical pickup 11. The optical pickup 11 including the LD 12 is reciprocally moved between an inner edge and an outer edge of the optical disk 10 so as to write data on and read data from the optical disk 10. The LD 12 is connected to the laser driver circuit 14.

The laser driver circuit 14 controls current intensity of the electric current so as to control a power of the laser beam.

The laser driver circuit 14 is connected to the APC circuit 16. The APC circuit 16 adjusts the voltage applied to the laser driver circuit 14 so as to maintain the laser power at a set value.

Reflected laser beam, which has been reflected from the optical disk 10, is received by a detector (not shown). Then, the detector sends reflection signals to an RF amplifier 18. The RF amplifier 18 amplifies the reflection signals.

The reflection signals amplified by the RF amplifier 18 are inputted to a servo processor 20. The servo processor 20 servo-controls rotation of a spindle motor 22 and focusing and tracking of the optical pickup 11 on the basis of the reflection signals.

A central processing unit (CPU) 24, which acts as control means, reads disk data from an ATIP of the optical disk 10 and checks if the optical disk 10 has two PCAs or not.

Further, if any data have been written on the optical disk 10, the CPU 24 reads the read-in area 4 of the optical disk 10 and detects a type of writing data as detecting means.

Note that, action of the CPU 24 is based on control programs previously stored in a memory 25.

A receiving and transmitting (R/T) section 44 receives signals from and sends signals to the host computer 50.

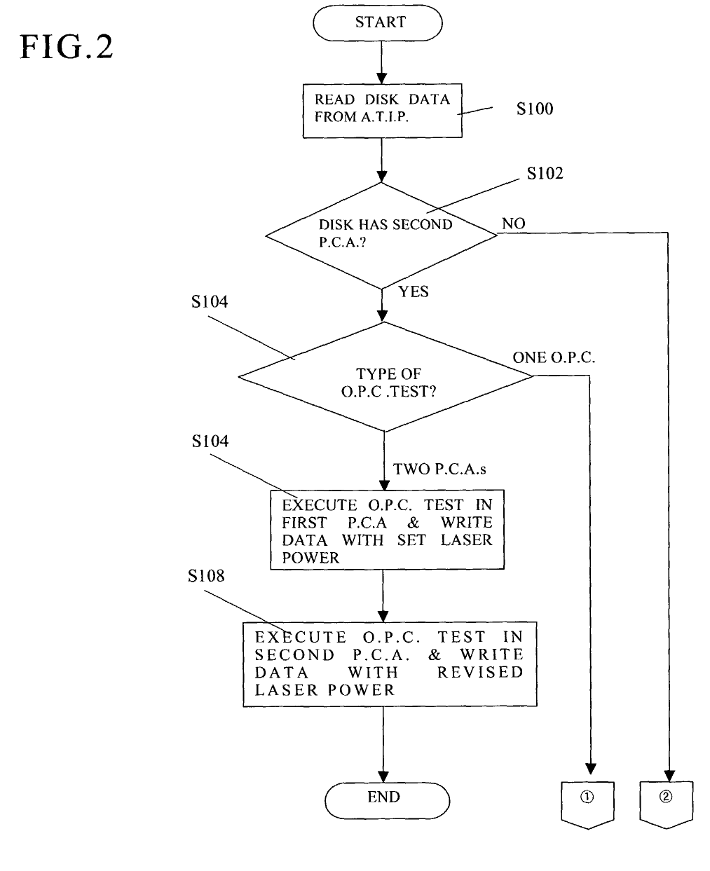

The method of the optimum power control test of a first embodiment will be explained with reference to a flow chart of FIG. 2.

When the optical disk 10 is set in the optical disk player 30 so as to write data thereon, the optical pickup 11 reads the disk data which have been written in the ATIP of the optical disk 10 (step S100).

The CPU 24 checks if the optical disk 10 has the second PCA 9 or not on the basis of the disk data read from the ATIP by the optical pickup 11 (step S102).

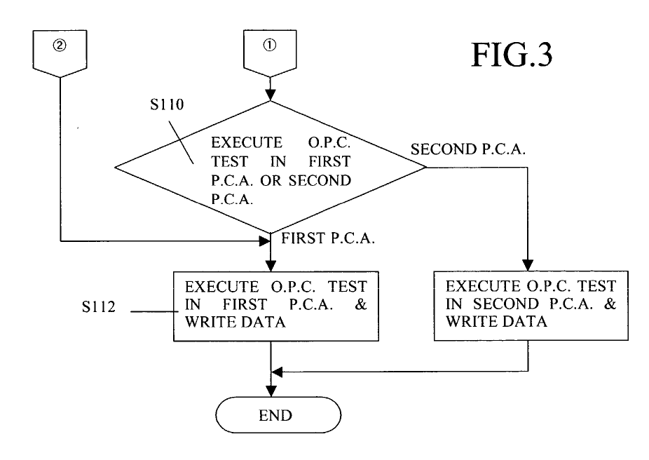

At the step S102, if the CPU 24 judges that the optical disk 10 has the second PCA 9, the CPU 24 executes the following step S104; if the CPU 24 judges that the optical disk 10 has no second PCA, the CPU 24 goes to step S112 (see FIG. 3).

At the step 104, the CPU 24 requests a user selection signal to the host computer 50. The host computer 50 asks a type of optimum power control test to the user. Namely, the host computer 50, which acts as selecting means, asks whether the optimum power control (OPC) test is executed in one of the PCAs 2 and 9 or in the both of the PCAs 2 and 9. This question is shown on a screen of a display unit.

The user watching the display of the host computer 50 selects the type of the OPC test and inputs a command of the selection.

When the user inputs the command to the host computer 50, the host computer 50 sends the user selection signal, which indicates the type of the OPC test, to the CPU 24. Upon receiving the user selection signal, the CPU 24 controls the APC circuit 16, the servo processor 20, etc. so as to execute the OPC test in the selected PCA 2 or 9 or in the both PCAs 2 and 9.

At the step S104, if the user selects the OPC test in the both PCAs 2 and 9, the CPU 24 goes to a step S106; if the user selects the OPC test in one of the PCAs 2 and 9, the CPU 24 goes to a step S110 (see FIG. 3).

At the step S106, the CPU 24 executes the OPC test in the first PCA 2 so as to define a proper laser power, then the CPU 24 controls the APC circuit 16, the servo processor 20, etc., so as to write data on the optical disk 10 with the set laser power.

When a position of writing data reaches a prescribed position of the optical disk 10, the CPU 24 controls the APC circuit 16, the servo processor 20, etc., so as to execute the OPC test in the second PCA 9. After the OPC test in the second PCA 9, data are written with the revised laser power set by the OPC test in the second PCA 9.

After executing the step S108, the CPU 24 completes the action of writing data on the optical disk 10.

While, at the step S104, if the user selects the OPC test in one of the PCAs 2 and 9, the CPU 24 goes to the step S110. At the step S110, the host computer 50 asks whether the OPC test is executed in the first PCA 2 or the second PCA 9 via the display.

When the user selects the PCA for executing the OPC test, the host computer 50 sends a selection command to the CPU 24. The CPU 24 controls the APC circuit 16, the servo processor 20, etc., so as to execute the OPC test in the selected PCA 2 or 9 on the basis of the selection command.

If the user selects the first PCA 2 at the step S110, the CPU goes to a step S112 and controls the APC circuit 16, the servo processor 20, etc., so as to execute the OPC test in the first PCA 2. Upon completing the OPC test in the first PCA 2, data are written with the laser power set by the OPC test in the first PCA 2.

After executing the step S112, the CPU 24 completes the action of writing data on the optical disk 10.

On the other hand, if the user selects the second PCA 9 at the step S110, the CPU goes to a step S111 and controls the APC circuit 16, the servo processor 20, etc., so as to execute the OPC test in the second PCA 9. Upon completing the OPC test in the second PCA 9, data are written with the laser power set by the OPC test in the second PCA 9.

After executing the step S111, the CPU 24 completes the action of writing data on the optical disk 10.

Note that, if the CPU 24 judges that the optical disk has no second PCA 9 at the step S102, the OPC test must be executed in the first PCA 2 only. Therefore, the CPU 24 goes to the step S112 and controls the APC circuit 16, the servo processor 20, etc., so as to execute the OPC test in the first PCA 2. Upon completing the OPC test in the first PCA 2, data are written with the laser power set by the OPC test in the first PCA 2.

After executing the step S112, the CPU 24 completes the action of writing data on the optical disk 10.

Next, a second embodiment of the method of the OPC test will be explained.

In the second embodiment, if the optical disk 10 has the first PCA 2 and the second PCA 9 and user data can be written in the second PCA 9, the OPC test is automatically executed in the first PCA 2. This is the characteristic of the second embodiment.

The optical disk player 30 shown in FIG. 1 can be used for executing the method of the second embodiment, so explanation of the optical disk player will be omitted. Note that, the CPU 24 acts as control means as well as the first embodiment.

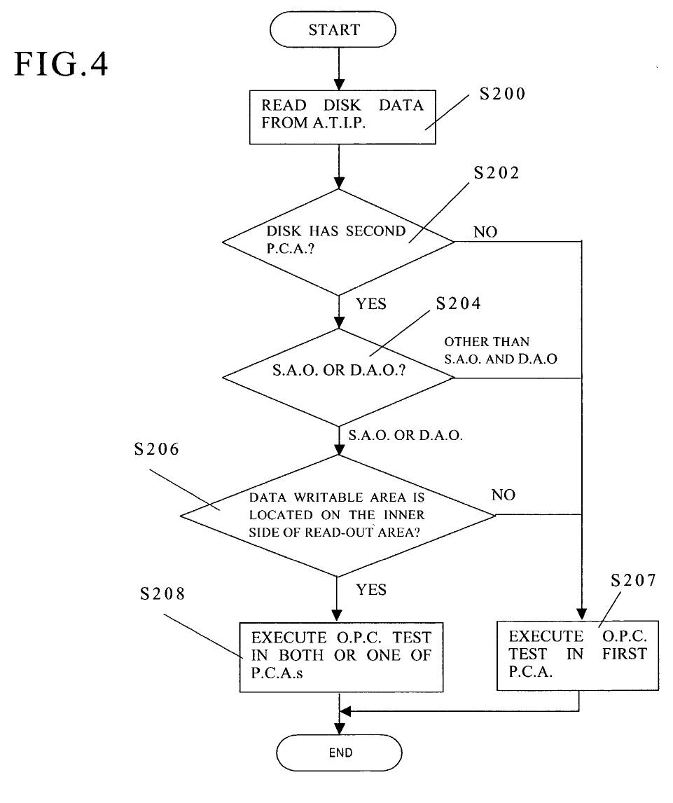

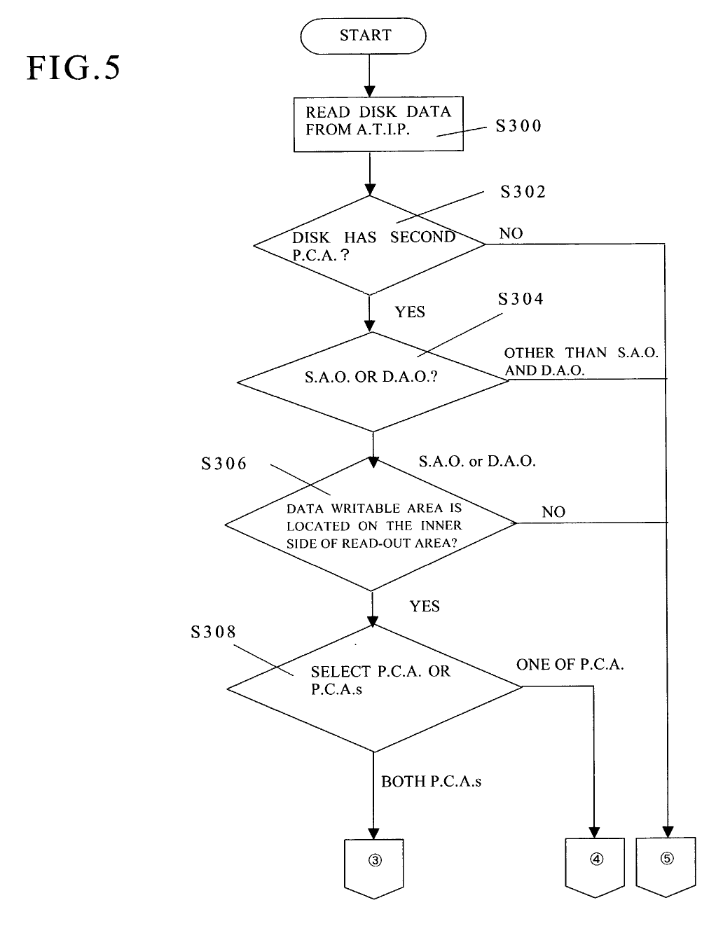

The method of the OPC test of the second embodiment will be explained with reference to flow charts of FIGS. 4 and 5.

Firstly, when the optical disk 10 is set in the optical disk player 30 so as to write data thereon, the optical pickup 11 reads the disk data which have been previously written in the ATIP of the optical disk 10 by a disk manufacturer (step S200).

The CPU 24 checks if the optical disk 10 has the second PCA 9 or not on the basis of the disk data read from the ATIP by the optical pickup 11 (step S202).

At the step S202, if the CPU 24 judges that the optical disk 10 has the second PCA 9, the CPU 24 executes the following step S204; if the CPU 24 judges that the optical disk 10 has no second PCA 9, the CPU 24 goes to step S207. At the step S204, the CPU 24 checks if a type of writing data of data already written on the optical disk 10 or that selected by the user is a session-at-once (SAO) type or a disk-at-once (DAO) type.

If any data have been written on the optical disk 10, the CPU 24 judges the type of writing data on the basis data written in the read-in area 4. On the other hand, if no data have been written on the optical disk 10, the CPU 24 judges the type of writing data on the basis a user's selecting command, which indicates the type of writing data and which has been sent from the host computer 50.

At the step S204, if the type of writing is the SAO type or the DAO type, the CPU 24 goes to a step S206; if the type of writing data is not the SAO type and the DAO type, the CPU 24 goes to a step S207.

The type of writing data in a CD-R and a CD-RW will be explained. If the type of writing data is the SAO type or the DAO type, a data writable area in the optical disk 10 can be known before writing data. Therefore, the CPU 24 can judge if data can be written in the second PCA 9 or not.

On the other hand, if the type of writing data is a track-at-once type, a packet-write type or a raw-write type, data can be added afterwards. Therefore, a final address of written data cannot be known before writing data. So, the OPC test of the optical disk, whose type of writing data is not the SAO type and the DAO type, is executed in the first PCA 2.

Further steps of the second embodiment will be explained.

At the step S206, if the type of writing data is the SAO type or the DAO type, the CPU 24 checks if the data writable area is located on the inner side with respect to the read-out area 8 or not. Namely, the CPU 24 judges a final address of data to be written on the optical disk 10.

If the data writable area extended over the read-out area 8, the CPU 24 goes to the step S207 so as not to use the second PCA 9.

On the other hand, if the data writable area is located on the inner side of the read-out area 8, the CPU 24 goes to a step S208.

At the step S208, the CPU 24 controls the APC circuit 16, the servo processor 20, etc. so as to execute the OPC test in the both of the PCAs 2 and 9 or in one of the PCAs 2 and 9.

On the other hand, at the step S207, if the OPC test is executed in the second PCA 9, written data will be overwritten. Therefore, the CPU 24 controls the APC circuit 16, the servo processor 20, etc. so as to execute the OPC test in the first PCA 2 only.

After the step S207 or S208, the OPC test of the second embodiment is completed.

Successively, a third embodiment of the method of the OPC test will be explained. The third embodiment is a combination of the first and the second embodiments. If no user data cab be written in the second PCA 9, the user can select the type of the OPC test executed in one of the PCAs 2 and 9 or in the both of the PCAs 2 and 9.

The optical disk player 30 shown in FIG. 1 can be used for executing the method of the third embodiment too, so explanation of the optical disk player 30 will be omitted. Note that, the CPU 24 acts as control means as well as the second embodiment.

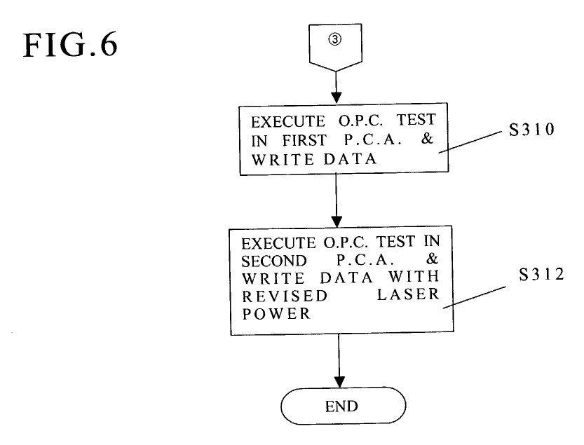

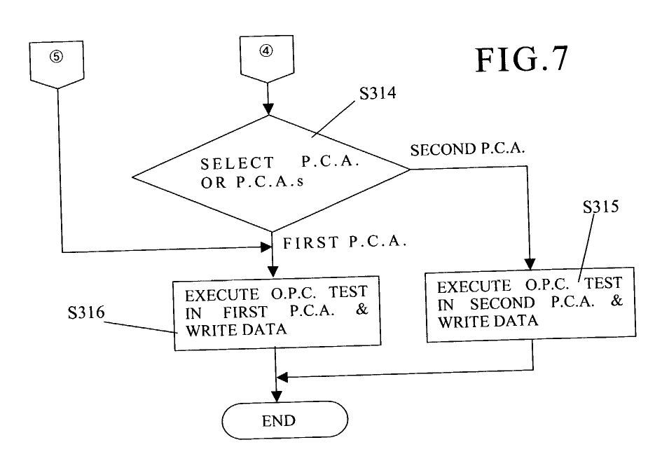

The third embodiment will be explained with reference to flow charts of FIGS. 5-7.

Firstly, when the optical disk 10 is set in the optical disk player 30 so as to write data thereon, the optical pickup 11 reads the disk data which have been previously written in the ATIP of the optical disk 10 by a disk manufacturer (step S300).

The CPU 24 checks if the optical disk 10 has the second PCA 9 or not on the basis of the disk data read from the ATIP by the optical pickup 11 (step S302).

At the step S302, if the CPU 24 judges that the optical disk 10 has the second PCA 9, the CPU 24 executes the following step S304; if the CPU 24 judges that the optical disk 10 has no second PCA 9, the CPU 24 goes to a step S316.

At the step S304, the CPU 24 checks if the type of writing data of data already written on the optical disk 10 or that selected by the user is the SAO type or the DAO type.

If any data have been written on the optical disk 10, the CPU 24 judges the type of writing data on the basis data written in the read-in area 4. On the other hand, if no data have been written on the optical disk 10, the CPU 24 judges the type of writing data on the basis a user's selecting command, which indicates the type of writing data and which has been sent from the host computer 50.

At the step S304, if the type of writing is the SAO type or the DAO type, the CPU 24 goes to a step S306; if the type of writing data is not the SAO type and the DAO type, the CPU 24 goes to a step S316. At the step S306, if the type of writing data is the SAO type or the DAO type, the CPU 24 checks if the data writable area is located on the inner side with respect to the read-out area 8 or not. If the data writable area extended over the read-out area 8, the CPU 24 goes to the step S316 so as not to use the second PCA 9.

On the other hand, if the data writable area is located on the inner side of the read-out area 8, the CPU 24 goes to a step S308.

At the step S308, the CPU 24 requests the user selection signal to the host computer 50. The host computer 50 asks the type of OPC test to the user. Namely, the host computer 50 whether the OPC test is executed in one of the PCAs 2 and 9 or in the both of the PCAs 2 and 9. This question is shown on the screen of the display unit of the host computer 50.

The user watching the display of the host computer 50 selects the type of the OPC test and inputs the command of the selection.

When the user inputs the command to the host computer 50, the host computer 50 sends the user selection signal, which indicates the type of the OPC test, to the CPU 24. Upon receiving the user selection signal, the CPU 24 controls the APC circuit 16, the servo processor 20, etc. so as to execute the OPC test in the selected PCA 2 or 9 or in the both PCAs 2 and 9.

At the step S308, if the user selects the OPC test in the both PCAs 2 and 9, the CPU 24 goes to a step S310; if the user selects the OPC test in one of the PCAs 2 and 9, the CPU 24 goes to a step S314.

At the step S310, the CPU 24 executes the OPC test in the first PCA 2 so as to define a proper laser power, then the CPU 24 controls the APC circuit 16, the servo processor 20, etc., so as to write data on the optical disk 10 with the set laser power.

When a position of writing data reaches a prescribed position of the optical disk 10, the CPU 24 controls the APC circuit 16, the servo processor 20, etc., so as to execute the OPC test in the second PCA 9 (step S312). After the OPC test in the second PCA 9, data are written with the revised laser power set by the OPC test in the second PCA 9.

After executing the step S312, the CPU 24 completes the action of writing data on the optical disk 10.

If the user selects the OPC test executed in one of the PCAs 2 and 9 at the step S308, the CPU 24 requests a selection signal to the host computer 50. The host computer 50 asks whether the OPC test is executed in the first PCA 2 or the second PCA 9. This question too is shown on the screen of the display unit of the host computer 50.

The user watching the display of the host computer 50 selects the PCA and inputs the command of the selection.

When the user inputs the command to the host computer 50, the host computer 50 sends the selection signal, which indicates the selected PCA 2 or 9, to the CPU 24. Upon receiving the selection signal, the CPU 24 controls the APC circuit 16, the servo processor 20, etc. so as to execute the OPC test in the selected PCA 2 or 9.

If the user selects the first PCA 2 at the step S314, the CPU goes to the step S316 and controls the APC circuit 16, the servo processor 20, etc., so as to execute the OPC test in the first PCA 2 only. Upon completing the OPC test in the first PCA 2, data are written with the laser power set by the OPC test in the first PCA 2.

After executing the step S316, the CPU 24 completes the action of writing data on the optical disk 10.

On the other hand, if the user selects the second PCA 9 at the step S314, the CPU goes to a step S315 and controls the APC circuit 16, the servo processor 20, etc., so as to execute the OPC test in the second PCA 9 only. Upon completing the OPC test in the second PCA 9, data are written with the laser power set by the OPC test in the second PCA 9.

After executing the step S315, the CPU 24 completes the action of writing data on the optical disk 10.

Note that, if the optical disk has no second PCA, the type of writing data is not the SAO type and the DAO type, or the data writable area is extended over the second PCA 9, the OPC test cannot be executed in the second PCA 9. Therefore, the CPU 35 goes to the step S 316.

At the step S316, the CPU 24 controls the APC circuit 16, the servo processor 20, etc., so as to execute the OPC test in the first PCA 2 only. Upon completing the OPC test in the first PCA 2, data are written with the laser power set by the OPC test in the first PCA 2.

After executing the step S316, the CPU 24 completes the action of writing data on the optical disk 10. The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. An optical disk player, which writes data on an optical disk having a first power calibration area located on an inner side of a read-in area and a second power calibration area located on an outer side of a read-out area,
comprising:
means for selecting a type of optimum power control test executed in one of the power calibration areas or in the both of the power calibration areas; and
control means for executing the optimum power control test in one of the power calibration areas or in the both of the power calibration areas on the basis of said selecting means.

2. An optical disk player, which writes data on an optical disk having a first power calibration area located on an inner side of a read-in area and a second power calibration area located on an outer side of a read-out area,
comprising:
means for detecting a type of writing data; and
control means for executing optimum power control test in the first power calibration area only if the type of writing data detected by said detecting means indicates that data can be written in the both power calibration areas.

3. The optical disk player according to claim 2,
Wherein said control mans executes the optimum power control test in the first power calibration area only if the type of writing data detected by said detecting means is a session-at-once type or a disk-at-once type.

4. The optical disk player according to claim 2,
further comprising means for selecting a type of optimum power control test executed in one of the power calibration areas or in the both of the power calibration areas if the type of writing data detected by said detecting means indicates that data can be written in the second power calibration area,
wherein said control means executes the optimum power control test in one of the power calibration areas or in the both of the power calibration areas on the basis of said selecting means.

5. A method of optimum power control test of an optical disk having a first power calibration area located on an inner side of a read-in area and a second power calibration area located on an outer side of a read-out area,
comprising the steps of:
selecting a type of the optimum power control test executed in one of the power calibration areas or in the both of the power calibration areas; and
executing the optimum power control test in one of the power calibration areas or in the both of the power calibration areas on the basis of the result of said selecting step.

6. A method of optimum power control test of an optical disk having a first power calibration area located on an inner side of a read-in area and a second power calibration area located on an outer side of a read-out area,
comprising the steps of:
detecting a type of writing data on the optical disk; and
executing the optimum power control test in the first power calibration area only if the type of writing data detected in said detecting step indicates that data can be written in the both power calibration areas.

7. A method of optimum power control test of an optical disk having a first power calibration area located on an inner side of a read-in area and a second power calibration area located on an outer side of a read-out area,
comprising the steps of:
detecting a type of writing data on the optical disk; and
executing the optimum power control test,
wherein the optimum power control test is executed in the first power calibration area only if the type of writing data detected in said detecting step indicates that data can be written in the both power calibration areas, or a type of the optimum power control test executed in one of the power calibration areas or in the both of the power calibration areas is selected if the type of writing data detected in said detecting step indicates that data cannot be written in the second power calibration area, and the optimum power control test is executed in one of the power calibration areas or in the both of the power calibration areas.
